(19) United States
(12) Patent Application Publication
(10) Pub. No.: US 2014/0032236 A1
(43) Pub. Date: Jan. 30, 2014

(54) System and Method of Electronic Tracking and Information Retrieval for the Integrity and Testing of Radiopharmaceutical Personal Protective Equipment

(71) Applicants: John Williams, Williamsburg, VA (US); Chetan S. Karani, Chantilly, VA (US)

(72) Inventors: John Williams, Williamsburg, VA (US); Chetan S. Karani, Chantilly, VA (US)

(73) Assignees: ODIN TECHNOLOGIES, Ashburn, VA (US); BURLINGTON MEDICAL SUPPLIES, INC., Newport News, VA (US)

(21) Appl. No.: 14/017,621

(22) Filed: Sep. 4, 2013

Related U.S. Application Data
(63) Continuation of application No. 13/684,771, filed on Nov. 26, 2012.
(60) Provisional application No. 61/588,893, filed on Jan. 20, 2012.

(51) Int. Cl. G06Q 50/22; G06Q 30/00

(52) U.S. Cl. CPC G06Q 50/22; G06Q 30/018
USPC 705/2

(57) ABSTRACT

An equipment inspection tracking system and method for radiopharmaceutical personal protective equipment which has a read-only RFID tag that allows a user to track, update, review and report a record of standard tracking and compliance history information. The system and method are customizable and can be used for large and varied quantities of radiopharmaceutical personal protective equipment. The system and method allow access by safety officers and compliance inspectors for required regulatory reporting. The system and method are accessible through a web browser or mobile application.

### CROSS-REFERENCE TO RELATED APPLICATION

This application is a continuation of U.S. application Ser. No. 13/684,771, filed Nov. 26, 2012, which claims priority to U.S. Provisional Application No. 61/588,893, filed Jan. 20, 2012, the contents of which are incorporated herein by reference in their entirety.

### BACKGROUND OF THE INVENTION

The present invention relates to equipment compliance tracking systems. In particular, it relates to computer systems and methods that allow for organizing and monitoring the compliance testing of large quantities of radiopharmaceutical personal protective equipment (“PPE”) across multiple facilities using radio frequency identification (“RFID”) tags to identify each PPE (the system and method collectively being a “Tracking System”).

PPE items are subject to periodic regulatory testing and compliance regulations. There are also potentially serious consequences to human health if PPE is not tested and maintained appropriately. Detailed records are required to be maintained and accessible both for the PPE owner's safety officer and, at least annually, by the hospital oversight agency, The Joint Commission (“JC”) (collectively, “Safety Monitors”), formerly The Joint Commission on Accreditation of Healthcare Organizations (“JCAHO”), a United States-based not-for-profit organization empowered to issue significant fines for failure to keep accurate records regarding PPE.

PPE includes radiopharmaceutical protective aprons, shields, eyewear, headwear, hoods, gloves and any other suitable gear.

The basis for the following described invention is a compelling need by hospitals, surgical centers, x-ray diagnostic centers and similar operators, to track the history and testing of PPE and maintain accessible records regarding PPE. PPE owners may include large hospital systems. A single PPE owner may have as many as 1,800 PPE items in inventory that in many instances may be identical in appearance, with no easily identifiable way to track them. Often, an owner's PPE inventory will exceed $5 million in value per location and there exists no effective method by which these owners may track PPE. Standard tracking information (“STI”) may include PPE size, type, manufacturer, style, serial number, manufacture date, purchase date, purchase order number, receiving office and department, type of material, protection levels, identifying markings, color, availability and user location (e.g., hospital location). Compliance History information (“Compliance History”) includes information related to PPE testing history, integrity, required regulatory testing cycle, alerts and reconditioning schedule. Additional tracking information (“ATI”) may include information such cost savings and return on investment. STI, Compliance History and ATI are together referred to as PPE (“Status”).

For standard tracking information, PPE owners have created methods such as attaching heavy metal tags to the PPE and affixing other labels, which have an identification number embossed on them, but these tags are often bulky and damage the PPE by the way they are coupled or attached (i.e., they create a hole in the PPE or interfere with its use). Current methods require that the PPE owner manually record the identification number and access a local database to determine or update any Status information of the item. This requires transporting the PPEs to a computer, transporting a computer to the various locations where the PPE items are stored; or taking the inventory in one location and entering data in another location, any of which will increase the likelihood of human error during transcription.

Other variations on tracking systems include embroidering or stamping an identification number on the PPE or sewing clear plastic envelopes on the PPE using colored pieces of paper to try to identify any Status information of the PPE. These approaches are inconsistent, slow, unreliable and difficult to perform. Additionally, the identification numbers that are embossed or stamped on PPE often fade or become illegible over time. Unfortunately, many tags in current systems are also subject to tampering and damage as they are readily viewable and accessible to any person in contact with the PPE. All current methods are cumbersome, require significant human interaction and have a high risk of error.

Typical systems work in the following manner:

1. A hole is punched into the PPE and a metal tag is inserted and attached or coupled. This tag interferes with the wearer's use of the equipment in that the tag must be sturdy enough not to bend or break.

2. The tag contains certain printed information about the PPE that cannot be changed.

3. When information such as the result of fluoroscope testing or damage to the item is to be recorded, the PPE owner must enter the PPE identification number manually at a local desktop computer and update the local database, said database often residing in a remote location for various reasons such as due the radiopharmaceutical equipment present in or near the room where the PPE is stored.

4. The information can only be accessed from a local computer and is, therefore, not easily accessible to the regulation authorities or in-house safety officers when requested.

RFID is commonly used in a variety of industries including radiopharmaceuticals, but it is typically used to identify the physical location of equipment or to actively monitor conditions related to workers. The present invention is not simply a system for determining the location of PPE or the conditions related to workers, but was designed to manage Compliance History of PPE, increase efficiency of testing and replacement of PPE, and decrease human error during the PPE compliance testing process. The present system is also designed to provide assurance to Safety Monitors that the Compliance History of PPE is being recorded and managed with increased accuracy, all for the increased safety of patients and workers. The present system also decreases costs.

The two general types of RFID systems are active and passive systems. With active RFID, the RFID device has an internal power source that allows the tag to transmit a radio frequency. With passive RFID, the RFID device relies on a strong signal being sent from a scanner (a scanner may also be referred to as a “reader”) to the tag, which activates the tag to reflect a signal back to the scanner. Passive RFID tags have a longer lifetime since they are not dependent on a finite power source, but passive RFID tags transmit a signal over a much shorter distance, generally just a few feet, and are capable of transmitting less information than active RFID tags. Passive RFID tags can currently communicate around 4 kb of information to a scanner.

Other systems fail to provide a method of permanently identifying PPE so an owner would easily be able to view the Status, more specifically, the Compliance History of the PPE with a high degree of confidence that such records were accurate and that the PPE was actually tested in accordance with regulatory requirements. Other systems have also failed to demonstrate a high degree of certainty that when PPE is tested, the correct record is updated. Other tracking systems do not provide a high degree of confidence that the records are accurate or limit the ability of individuals to make certain types of changes to PPE records. Also, other systems fail to provide an automated way to determine if certain PPE have been scanned and tested within the regulatory time limits.

What is needed is a reliable way: (i) to identify PPE without damaging it, while also having a permanently attached or coupled identification tag on it; (ii) to decrease the likelihood of mis-identification when an individual accesses the record of the PPE; (iii) to alert an administrator when an article of PPE is damaged or lost based on regulatory time period set within the tracking system; (iv) to provide an easy way for a user to quickly identify for a Safety Monitor the Compliance History of PPE; (v) to create general reports regarding PPE Compliance History for the Safety Monitor; (vi) to allow an owner of PPE to identify facilities where excess quantities of PPE are located; and (vii) to allow the PPE owner's safety officer to control and limit the number of individuals with access to update or modify the Compliance History record of PPE.

### SUMMARY OF THE INVENTION

The present invention solves the foregoing problems by relying on a permanently attached read-only RFID tag coupled to each PPE item being tracked by the Tracking System, which facilitates information retrieval regarding the Status, including the Compliance History, of PPE. The RFID tag may, in one embodiment, be 1.6″ by 2.125″ and made to be bendable so that the tag can easily be attached or coupled to the PPE.

In one embodiment, the RFID tag of the Tracking System is a passive RFID tag, which stores identification information about the PPE such that the identification information cannot be altered without replacing its RFID tag and so the identification number cannot be easily worn off or determined by an unauthorized individual upon seeing the PPE item. The information carried on the RFID tag may be, in one embodiment, be as basic as a unique identification number that identifies that PPE, but also may carry additional identification information about the PPE, including any unchangeable information related to a PPE's Status, such as STI.

The Tracking System uses the identification information stored on the RFID tag to identify the PPE without the need for manual data entry. The Tracking System then associates the PPE with an electronic record for that PPE, which record is maintained by the Tracking System. The Tracking System uses a suitable database and database management system capable of storing information about the PPE, but the particular type of database or database management system may vary. The database used may be a SQL server database. The Tracking System may use one or more RFID tag scanners, and the particular type of scanner may vary so long as it is compatible with the particular RFID tags being used on the PPE and is in communication with the Tracking System. The database for the Tracking System may be located on a network or in a cloud environment so that its records can be accessed from any location through a web-based user interface, mobile application, etc.

As with any inventory management system, the Tracking System should have the ability to create reports that are customizable to show and filter for certain characteristics about items of PPE.

The present invention may further comprise the ability to allow a person testing PPE to enter the physical location of the PPE or may accept GPS information from the user interface device to record the exact location of the PPE at each testing (whether by facility or by physical location within a facility).

In another aspect of the present invention, the RFID tags can be programmed with additional information, security and password protection.

In another aspect of the present invention, the attachment is modified to fit different shapes and sizes of passive RFID tags.

In another aspect of the present invention, the information stored on the RFID tags is in accordance with the International Standards Organization (e.g., ISO 9001:2008) to allow for use of the tagged PPE with multiple tracking systems.

These and other advantages of the invention will be further understood and appreciated by those skilled in the art by reference to the following written specifications, claims and appended drawings.

### BRIEF DESCRIPTION OF DRAWINGS

FIG. 1 is a flow diagram showing how a new PPE is entered into one embodiment of the Tracking System; and

FIG. 2 is a flow diagram showing the steps a user may take to manage an inventory of PPE in one embodiment of the Tracking System.

### DETAILED DESCRIPTION OF THE PREFERRED EMBODIMENT(S)

It is to be understood that the specific devices and processes illustrated in the attached drawings and described in the following specification are exemplary embodiments of the inventive concepts defined in the claims below. Hence, specific dimensions and other physical characteristics relating to the embodiments disclosed herein are not to be considered as limiting, unless the claims expressly state otherwise.

The Tracking System has many advantages to systems and methods currently in use.

The Tracking System comprises the system and method of: permanently attaching a read-only RFID tag programmed with an identification number to a PPE item; assigning the RFID tag (and its corresponding PPE item) an identification number corresponding to the PPE's record in the Tracking System's database; maintaining the Status, including the Compliance History, of a PPE in the Tracking System's database over a specified period of time. The RFID tag is scanned or read with a scanner which is in communication with the Tracking System. The Tracking System receives the information related to the identification number from the scanner and retrieves the aforementioned and corresponding record containing the Status, including the Compliance History, from the Tracking System's database based on that identification number. The Tracking System then communicates the retrieved record to the user through a user interface.

The RFID tag is permanently attached or coupled to the PPE such that the PPE itself is not breached, including by adhesive, permanent snaps and/or sewing it into a pocket or envelope on the PPE. By attaching the RFID tags in such a manner, the integrity of the PPE is preserved (e.g., there are no holes or other damage to the PPE).

The Tracking System may be accessible by mobile devices, including phones and tablets.

The Tracking System provides a convenient system and method for tracking PPE over the life of the PPE. The Status, including the Compliance History, of a PPE or group of PPEs can be reliably audited and reported using the Tracking System without the Safety Monitor physically seeing the PPE during the audit. An additional feature of this system is that the permanent RFID tag reduces expenses associated with tagging PPE that exist in other systems as the RFID tags may be attached as part of the manufacturing process.

Another advantage of RFID is that the scanner need not be within view of the RFID tag, as is required in other systems such as bar coding. This reduces errors and allows the record for a PPE to be identified and retrieved without manual entry of the identification number. This is especially important because many PPEs are otherwise identical to each other and are often cumbersome to handle and scan. Reducing the physical labor required to transport PPE for testing saves money.

While RFID tags are available as active (battery operated) or passive (no battery), passive RFID tags are preferred because they are less expensive, and have greater longevity. Passive RFID tags must be within the range of twenty-six inches or less from the scanner, but range is not a critical factor for the present Tracking System because each PPE is subject to periodic physical inspection and is typically stored in a designated location. During these inspections, PPE (and attached RFID tags) can be placed within range of a scanner, or a mobile scanner could be used in the applicable PPE storage areas as needed.

Yet another feature is that the Tracking System's record of the Status, including the Compliance History, is not impacted if an RFID tag is damaged because it is stored in the Tracking System's database. The Tracking System may also be configured to issue an alert if, for example, the Compliance History of a PPE has not been updated within a set period of time, prompting an investigation for the missing or damaged PPE.

Unlike with longer range active RFID tags, the use of passive RFID tags also allows the items of PPE to be more easily distinguished from each other by a scanner because the RFID tags can easily be separated from the other tags within the same vicinity, such as in a closet or room. This feature, among others, reduces the potential for PPE identification error when updating the record for a PPE. At the same time, a passive RFID still allows a room full of PPEs to be scanned quickly without manually entering identification information for each PPE.

In one embodiment, the Tracking System database is managed by the manufacturer of the PPE to decrease costs by eliminating redundant systems operated by each PPE owner, by pre-programming RFID tags and by populating the Tracking System database with the PPE records prior to delivery of the PPE items to the PPE owner.

Unlike currently available products and services, this system allows the user to maintain large inventories of PPE, saving the owner significant costs by avoiding ordering unnecessary additional PPE and over-testing PPE that it already owns. As many owners have multiple facilities, this cost savings can be multiplied.

In addition, the Tracking System can instantly show a Safety Monitor the Status, including the Compliance History, of all PPEs without physically locating each item. The Tracking System can scan one RFID tag and instantly retrieve the history of a particular PPE in response to an inquiry about that particular item on a computer or mobile device. There is no slowdown or human error commonly associated with writing numbers down and trying to access a database accessible from a single computer. The system and method is efficient, easy to use and inexpensive compared to currently available systems and methods.

Additionally, as described above, the Tracking System allows users to manage equipment across many hospitals and allows owners to assess the condition and suitability of idle equipment so that it may be reallocated to facilities in need of additional equipment. The system may also be configured to monitor the timing of PPE replacement or reconditioning, depreciation calculations, cost savings and return on investment.

In a first embodiment (not depicted in the figures), The present invention and method may comprise the following steps:

1. The PPE owner purchases or subscribes to the Tracking System and selects options for Status, including Compliance History, management and testing cycles.

2. The PPE owner may use any commonly available computer with a web browser to access the Tracking System.

3. Each purchased PPE item already has a read-only RFID tag permanently attached or coupled to it.

4. The read-only RFID tag is permanently programmed with an identification number corresponding to a record in the Tracking System's database.

5. Additional identification information and user selected information may also be programmed onto the read-only RFID tag when programmed either by the manufacturer or the user (“Pre-programming”). Such Pre-programming may include unchangeable information related to a PPE, such as STI (i.e., purchase date, purchase order number, size, receiving department or other information suitable to a particular PPE owner's needs).

6. When the owner first receives the PPE item, the owner may scan the RFID tag with a compatible RFID scanner which “tells” the Tracking System to retrieve the record associated with that particular PPE from a database.

7. The PPE owner would then conduct the initial test of the integrity of the PPE to assure its safety (e.g., for lead aprons by using fluoroscopy equipment, a type of medical imaging regulated by the FDA that shows a continuous x-ray image).

8. The safety testing reveals to the owner any flaws that may occur due to mishandling or misuse of the PPE item as well as any flaws in the manufacturing process that may have occurred (flaws include but are not limited to holes in the PPE material, creases in the material that can let in radiation, and/or tears in the PPE that require the item to be replaced).

9. The Tracking System allows manual data entry of new STI, Compliance History and ATI into the record, and the Tracking System database stores the new Compliance History information and builds a Compliance History record associated with the PPE.

10. At any time, the Tracking System allows the customer to check the Status, including the Compliance History, of a PPE item thereby eliminating uncertainty and unnecessary testing of previously tested aprons.

11. The Tracking System allows a safety officer to run reports and check PPE Compliance History from any computer or mobile device through a web-based browser or mobile application and provides immediate feedback as to the testing schedule of a PPE item during a Safety Monitor review.

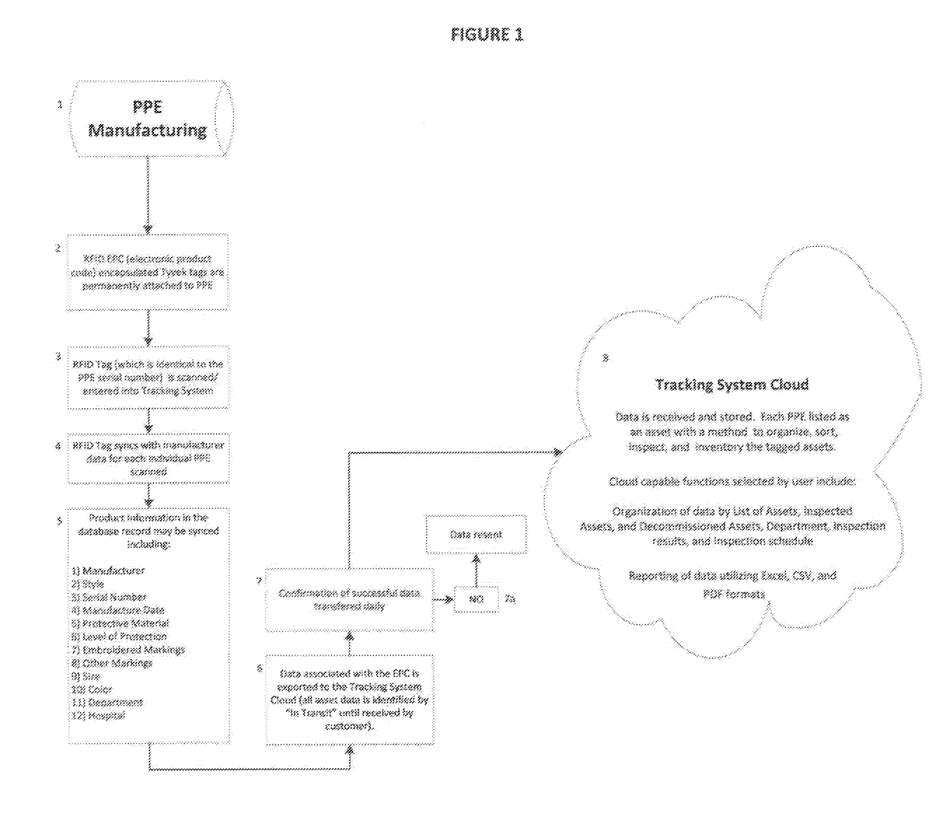

In a second embodiment, as shown in FIG. 1, the PPE is manufactured 1, and then the RFID tag is permanently attached or coupled to the PPE and encoded with a serialized identification number 2. Then the RFID tag is scanned to synchronize it with the corresponding information from the Tracking System's database 4. Then a record set is created or accessed and certain Compliance History information about the PPE is entered or updated in the database record for the PPE 5. Next, locally entered data is exported to the Tracking System cloud 6, and the Tracking System confirms to the user that it is received 7. Once the remote Tracking System receives the Compliance History information, the PPE becomes available in the Tracking System database, and the Tracking System allows it to be organized, sorted, inspected with the other PPEs in the Tracking System cloud 8.

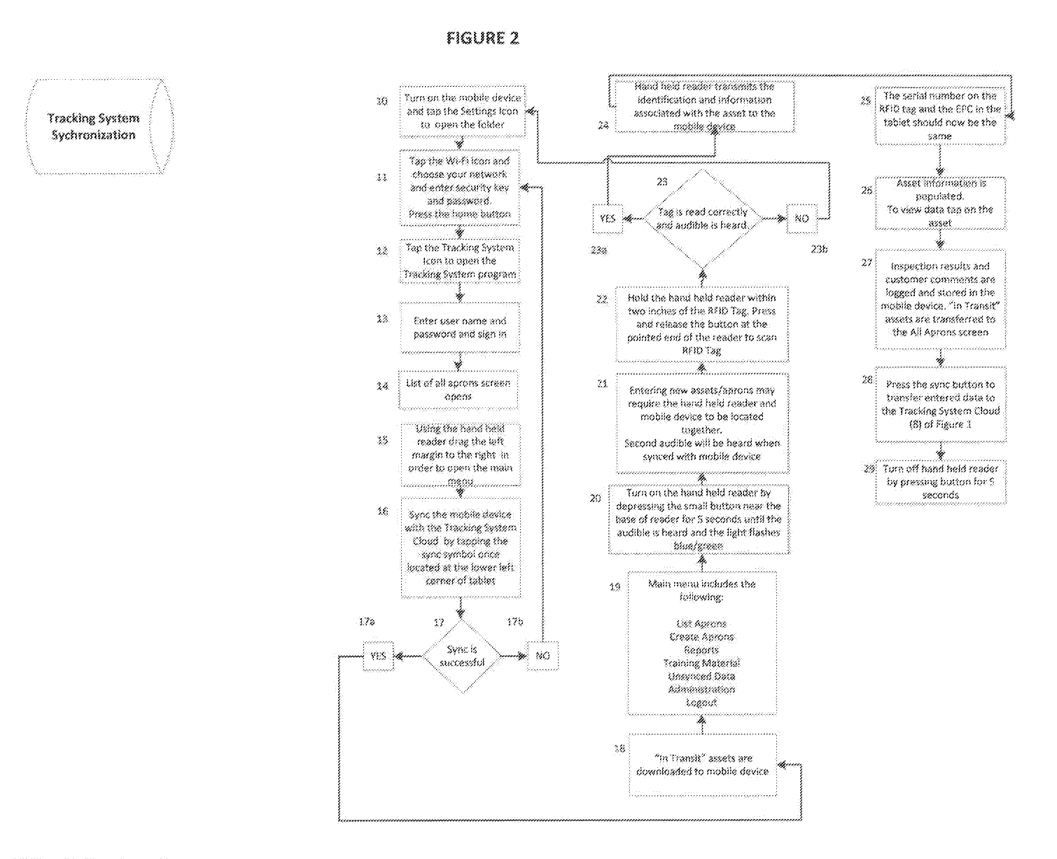

In a third embodiment, as shown in FIG. 2, a mobile device is turned on 10 and connected to a wireless network 11. A local application for the Tracking System is opened 12, and the user signs into the Tracking System 13. The list of PPE screen (in this embodiment, aprons) opens 14, and the user may also go to the main menu 15. The local application may be synchronized with a remote Tracking System cloud 16, 17. New information about the PPE is then downloaded to the mobile device (in this embodiment, the new information is identified as “In Transit” until synchronized) 18. The main menu for the local application will then display a list of options, in this embodiment, a list of aprons, ability to add new aprons, create reports, access training material, identify unsynchronized information, administration options and a logout 19. A scanner can then be activated 20, and connected (wirelessly or by physical connection) to the mobile device 21. Once the scanner is held within two (2) inches of the RFID tag, the scanner may be activated to scan the RFID tag 22. If the RFID tag scans correctly, the scanner then makes an audible acknowledgement 23 and transmits the identification information about the PPE from the RFID tag to the mobile device 24. The local application on the mobile device then determines the appropriate PPE record based on the identification information scanned 25, and the Tracking System populates the Status, including the Compliance History, of that PPE 26. If new inspection results or comments are entered into about the PPE, then those comments are identified as “In Transit” 27. The In Transit information on the mobile device may be synchronized 28 with the Tracking System cloud (FIG. 1, 8).

Preferred embodiments of this invention are described herein. Variations of those preferred embodiments may become apparent to those having ordinary skill in the art upon reading the foregoing description. The inventors expect that skilled artisans will employ such variations as appropriate, and the inventors intend for the invention to be practiced other than as specifically described herein. Accordingly, this invention includes all modifications and equivalents of the subject matter recited in the claims appended hereto as permitted by applicable law. Moreover, any combination of the above-described elements in all possible variations hereof is encompassed by the invention unless otherwise indicated herein or otherwise clearly contradicted by context.

While the disclosure above sets forth the principles of the present invention, with the examples given for illustration only, one should realize that the use of the present invention includes all usual variations, adaptations and/or modifications within the scope of the claims attached as well as equivalents thereof

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing an invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., “including, but not limited to,”) unless otherwise noted. Recitation of ranges as values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention (i.e., “such as, but not limited to,”) unless otherwise claimed. No language in the specification should be construed as indicating any non-claimed element as essential to the practice of the invention.

Those skilled in the art will appreciate from the foregoing that various adaptations and modifications of the just described embodiments can be configured without departing from the scope and sprit of the invention. Therefore, it is to be understood that, within the scope of the appended claims, the invention may be practiced other than as specifically described herein.

What is claimed is:

1. An equipment inspection tracking system comprising:
a data processing system;
at least one network;
a user interface;
at least one database;
a plurality of radiopharmaceutical personal protective equipment;
a radio frequency identification tag attached to each of the plurality of equipment and having identification information corresponding to the equipment to which the tag is attached;
a customized record of standard tracking information and compliance history information for each of the plurality of equipment, said record located on the at least one database; and
a scanner;
wherein the data processing system is configured to communicate with the scanner and the at least one database over the at least one network;
wherein the scanner transmits the identification information to the data processing system; and
wherein the data processing system matches the identification information with the record for each of the plurality of equipment, updates and maintains the record, and communicates the record to the at least one user interface, allowing a user to view and make updates to the record.

2. The system of claim 1, further comprising an attachment, which permanently couples the radio frequency identification tag to one of the plurality of equipment.

3. The system of claim 1, further comprising an attachment, which couples the radio frequency identification tag to one of the plurality of equipment and does not compromise the integrity of the equipment or interfere with its use.

4. The system of claim 1, further comprising a network, wherein the at least one database communicates with the data processing system through a different network than the at least one scanner.

5. The system of claim 1, further comprising an attachment that is coupled to one of the plurality of equipment by the manufacturer of the equipment.

6. The method of claim 1, further comprising a security measure to control access to the record of one of the plurality of equipment.

7. The system of claim 1, further comprising a data processing system that is configured to generate an alert if the scanner is unable to communicate with the radio frequency identification tag properly.

8. The system of claim 1, further wherein the record is built through the updates.

9. The system of claim 1, further comprising an alert indicating that one of the plurality equipment requires testing.

10. The system of claim 1, further comprising multiple computing and mobile devices configured to access the system.

11. The system of claim 1, further comprising a central point of control configured to manage the plurality of equipment at multiple locations.

12. A method for equipment inspection tracking comprising:
acquiring identification information about one of a plurality of radiopharmaceutical personal protective equipment transmitted from a networked scanner, the scanner receiving the identification information transmitted from a passive radio frequency identification tag, the passive radio frequency identification tag attached to one of the plurality of equipment;
retrieving a compliance history record associated with the identification information from a database; and
determining a compliance history status of one of the plurality of equipment by comparing the compliance history record associated with the identification information against an applicable regulatory deadline.

13. The method of claim 12, further comprising updating the compliance history record of one of the plurality of equipment in the database.

14. The method of claim 12, further comprising reviewing the compliance history record.

15. The method of claim 12, further comprising controlling access to the record of one of the plurality of equipment using a security measure.

16. A method of inspecting and tracking a plurality of radiopharmaceutical personal protective equipment, using an equipment inspecting and tracking system, comprising:
acquiring identification information about one of a plurality of radiopharmaceutical personal protective equipment transmitted from a networked scanner, the scanner receiving the identification information transmitted from a passive radio frequency identification tag, the passive radio frequency identification tag attached to one of the plurality of equipment;
retrieving a compliance history record associated with the identification information from a database; and
determining a compliance history status of one of the plurality of equipment by comparing the compliance history record associated with the identification information against an applicable regulatory deadline;
said system comprising:
a data processing system; at least one network; a user interface; at least one database; a plurality of radiopharmaceutical personal protective equipment; a radio frequency identification tag attached to each of the plurality of equipment and having identification information corresponding to the equipment to which the tag is attached; a customized record of standard tracking information and compliance history information for each of the plurality of equipment, said record located on the at least one database; and a scanner;
wherein the data processing system is configured to communicate with the scanner and the at least one database over the at least one network;
wherein the scanner transmits the identification information to the data processing system; and
wherein the data processing system matches the identification information with the record for each of the plurality of equipment, updates and maintains the record, and communicates the record to the at least one user interface, allowing a user to view and make updates to the record.

17. An equipment inspection tracking kit comprising:
a plurality of radio frequency identification tags to retrofit a plurality of radiopharmaceutical personal protective equipment;
a handheld scanner; and
a local software application that synchronizes with a remote inspecting and tracking system.

18. The kit of claim 17, wherein said remote system comprises:
a data processing system; at least one network; a user interface; at least one database;
identification information corresponding to the equipment stored in each of the plurality of tags;
and a customized record of standard tracking information and compliance history information for each of the plurality of equipment, said record located on the at least one database;
wherein the data processing system is configured to communicate with the scanner and the at least one database over the at least one network;
wherein the scanner transmits the identification information to the data processing system; and
wherein the data processing system matches the identification information with the record for each of the plurality of equipment, updates and maintains the record, and communicates the record to the at least one user interface, allowing a user to view and make updates to the record.

19. The system of claim 18, further comprising an attachment, which permanently couples the radio frequency identification tag to one of the plurality of equipment.

20. The system of claim 18, further comprising an attachment, which couples the radio frequency identification tag to one of the plurality of equipment and does not compromise the integrity of the equipment or interfere with its use.

21. The system of claim 18, further comprising a network, wherein the at least one database communicates with the data processing system through a different network than the at least one scanner.

22. The system of claim 18, further comprising an attachment that is coupled to one of the plurality of equipment by the manufacturer of the equipment.

23. The method of claim 18, further comprising a security measure to control access to record of one of the plurality of equipment.

24. The system of claim 18, further comprising a data processing system that is configured to generate an alert if the scanner is unable to communicate with the radio frequency identification tag properly.

25. The system of claim 18, further wherein the record is built through the updates.

26. The system of claim 18, further comprising an alert indicating one of the plurality equipment requires testing.

27. The system of claim 18, further comprising multiple computing and mobile devices configured to access the system.

28. The system of claim 18, further comprising a central point of control configured to manage the plurality of equipment at multiple locations.
